(19) United States
(12) Patent Application Publication
(10) Pub. No.: US 2003/0160202 A1
(43) Pub. Date: Aug. 28, 2003

(54) Valve for controlling fluids

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/221,791

(22) PCT Filed: Dec. 22, 2001
(86) PCT No.: PCT/DE01/04918

(30) Foreign Application Priority Data
Jan. 17, 2001 (DE) 101-07-799.5

(51) Int. Cl. F16K 31/02

(52) U.S. Cl. 251/229; 251/58; 251/129.06; 251/129.2

(57) ABSTRACT

The present invention relates to a valve for controlling fluids, which has an actuator (2) and a mechanical booster (3) for boosting a stroke of the actuator (2). A restoring spring (4) and a valve element (6) are also provided. The booster (3) is embodied as a kidney-shaped tilt lever (13, 14, 23), which has point-type bearing points.

### PRIOR ART

The present invention relates to a valve for controlling fluids as generically defined by the preamble to claim 1.

Valves for controlling fluids are known in various designs. For instance from U.S. Pat. No. 4,022,166, a piezoelectric fuel injection valve is known, in which the control of the valve member is effected via a piezoelectric element. The stroke of the piezoelectric element is transmitted directly to the valve needle via a lever. Moreover, two restoring springs are provided, for keeping the valve needle and the lever each in their respective outset position. Because of this embodiment with two restoring springs in contact with one another via the lever, the result is a structure that is very vulnerable to vibration and in particular is not suitable for high-pressure injection, since the vibrations can escalate. As a result, because of the mechanical boost, only very slight rigidity can be achieved in this valve, and this adversely affects the precision of injection.

Furthermore, injectors are known which use hydraulic boosters to boost the stroke of a piezoelectric actuator. However, such embodiments generally have a relatively complicated structure and comprise many parts. Moreover, in hydraulic boosts it is disadvantageous that the rigidity of the system is again relatively slight, since the hydraulic boost is very great (approximately 1:8).

Since the piezoelectric actuators have only a very slight stroke capacity, the complexity and expense for the known mechanical or hydraulic boosts are relatively great, yet only a relatively slight rigidity is achieved.

### ADVANTAGES OF THE INVENTION

The valve for controlling fluids of the invention, as defined by the characteristics of claim 1, has the advantage over the prior art that as a mechanical booster it has a kidney-shaped tilt lever, which assures high rigidity in the boosting operation. Moreover, by using kidney-shaped tilt levers as boosters, it can attained that the mechanical booster has only point-type bearing points, so that only slight friction occurs in the booster. Since the mechanical booster is embodied as a kidney-shaped tilt lever, the tilt lever is embodied quite compactly and can assure a rigid boost in the stroke of an actuator. Depending on the geometric design of the kidney-shaped tilt lever, the boosting ratio of the mechanical booster can also be determined in a simple way. In comparison with the known mechanical boosters of the prior art, the valve for controlling fluids of the invention thus has a simple, compact structure. The tilt lever of the invention is in particular characterized by the fact that because of the kidney-shaped embodiment of the tilt lever, two bearing points are embodied on one side of the tilt lever, and one bearing point is embodied on a side of the tilt lever opposite that side. The kidney-shaped tilt lever thus furnishes a rocker-like boosting motion, and the bearing point located on one side of the tilt lever preferably forms the pivot axis of the tilt lever.

In a preferred feature of the present invention, the mechanical booster embodied as a tilt lever is laterally positionally fixed in a transverse axis. A transverse axis is understood here to mean an axis that is perpendicular to a longitudinal axis of the tilt lever; the longitudinal axis extends through the two bearing points disposed on one side of the tilt lever. As a result, the transverse axis also forms the pivot axis of the kidney-shaped tilt lever, so that one bearing point of the tilt lever can be replaced by the lateral positional fixation.

Preferably, the positional fixation of the tilt lever is effected by means of a shaft guided by the tilt lever, or by means of two lateral, pointlike guide elements. The shaft guided by the tilt lever is supported laterally of the kidney-shaped tilt lever. Depending on the disposition of the shaft, the boosting ratio of the tilt lever can as a result also be changed. Similarly to the shaft, the two guide elements are disposed laterally of the tilt lever. Preferably, the guide elements are embodied as guide lugs or as pointlike protrusions, which can engage correspondingly formed recesses in the tilt lever. The result is a bearing performance similar to that of the shaft guided by the tilt lever.

In another preferred feature of the present invention, the tilt lever has precisely three bearing points. The bearing points are disposed on the tilt lever in such a way that two bearing points are embodied on one side of the respectively protruding regions of the kidney-shaped tilt lever, and the third bearing point is embodied longitudinally between the other two bearing points, on the opposite side of the tilt lever. The third bearing point acts as a pivot axis about which the tilt lever pivots. The boosting ratio of the tilt lever is determined by the location of the third bearing point between the other two bearing points.

Preferably, the actuator of the valve for controlling fluids is connected to an actuating element that actuates the tilt lever. In other words, the actuating element is disposed between the actuator and the tilt lever. Because of this disposition of the actuating element between the actuator and the tilt lever, structural freedoms in terms of the disposition of the tilt levers are obtained in particular. It should be noted that as the actuator, a piezoelectric actuator can preferably be used, or a magnet element.

To furnish a relatively simple design of the booster of the invention, the actuating element is preferably embodied as a bridge or plate, or is characterized in that the actuating element has a tapering tip. The tapering tip of the actuating element is preferably embodied as a cone, as a hemisphere, or as an element with a jacket region that is parabolic in section. This makes it possible for the actuating element to engage an outermost end point of the tilt lever, making an especially high boosting ratio attainable, without having to use a tilt lever with an excessively great length.

To furnish the boost in the stroke of the actuator with an especially high rigidity, the mechanical booster is preferably formed by many tilt levers. This also makes it possible to distribute the actuating force to a plurality of tilt levers, reducing the load on the individual tilt levers.

Especially preferably, the mechanical booster is embodied symmetrically. This makes a uniform introduction of force into the mechanical booster possible, so that no unnecessary forces are transmitted to the housing of the valve.

In a further preferred feature of the present invention, the valve element is embodied integrally on the actuating piston. A seat diameter of a valve seat is equivalent to a guide diameter of the actuating piston. As a result, in particular, an ideally force-balanced valve can be furnished.

The valve for controlling fluids of the invention is advantageously used in an injection device for a common rail system. Especially preferably, it is used as a control valve of an injector. In particular, the advantages of the valve of the invention in terms of the high rigidity can then be especially well exploited.

According to the invention, a valve for controlling fluids is thus furnished which, because of a mechanical booster embodied as a kidney-shaped tilt lever with point-type bearing points, has a very high system rigidity yet a particularly compact design. As a result, it is possible in particular to perform the injection event upon fuel injection in common rail injection systems more precisely and to further improve it.

### DRAWINGS

A plurality of exemplary embodiments of the invention are described in further detail in the ensuing description. Shown are:

FIG. 1, a schematic sectional view through a control valve for a fuel injection valve, in a first exemplary embodiment of the present invention;

FIG. 2, a schematic sectional view through a control valve for a fuel injection valve, in a second exemplary embodiment of the present invention;

FIG. 3, a schematic sectional view through a fuel injection valve having a control valve in a third exemplary embodiment of the present invention;

FIG. 4, an enlarged sectional view of the actuating piston shown in FIG. 3;

FIG. 5, a sectional view taken along the line A-A in FIG. 3;

FIG. 6, a schematic sectional view of a control valve in a fourth exemplary embodiment of the present invention;

FIGS. 7a-7c, schematic sectional views through various actuating elements for the fourth exemplary embodiment of the present invention;

FIGS. 8a and 8b, schematic sectional views through various mechanical boosters in the fourth exemplary embodiment of the present invention; and

FIG. 9, a schematic sectional view through a control valve for a fuel injection valve, in a fifth exemplary embodiment of the present invention.

### DESCRIPTION OF THE EXEMPLARY EMBODIMENTS

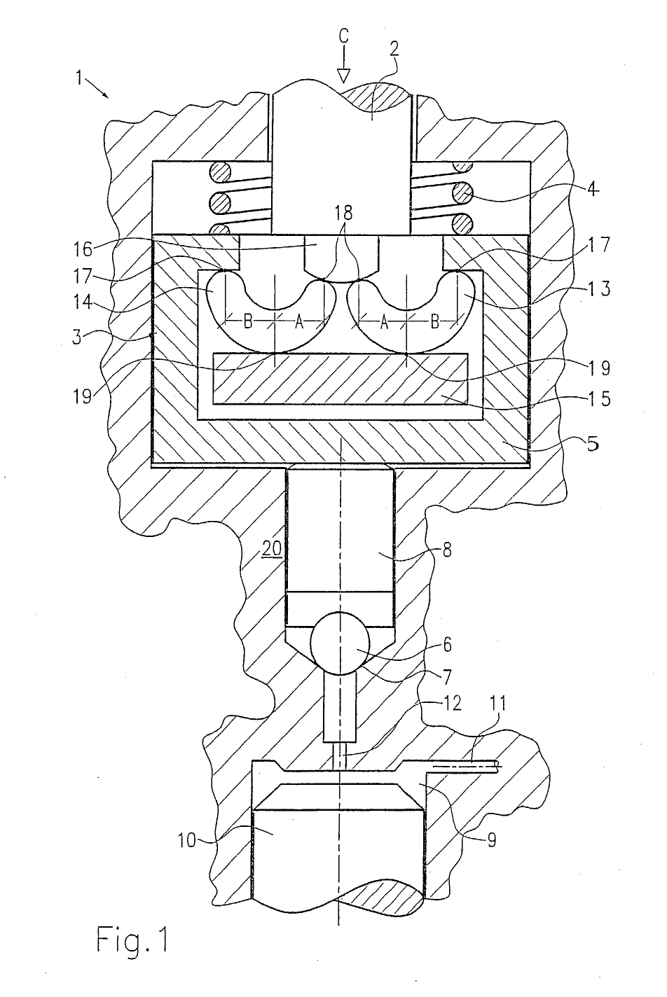

FIG. 1 shows a control valve 1 for a fuel injection valve in a common rail system, in a first exemplary embodiment of the present invention.

As shown in FIG. 1, the control valve includes a piezoelectric actuator 2 as its actuator, a mechanical booster 3, and a restoring spring 4. The piezoelectric actuator 2 is in contact with two kidney-shaped tilt levers 13 and 14 via a platelike actuating element 16. More precisely, the platelike actuating element 16 forms one bearing point 18 each with each kidney-shaped tilt lever 13 and 14, respectively. On the same side as the first bearing point 18, a second bearing point 17 is also provided at each kidney-shaped tilt lever 13, 14. Via this second bearing point 17, the two tilt levers 13 and 14 are in contact with a bridgelike intermediate member 5, which is in contact with a valve element 6 via a piston 8.

A third bearing point 19 of the kidney-shaped tilt levers 13 and 14 is formed on the side of the tilt levers 13 and 14 opposite the two bearing points 17 and 18 (see FIG. 1). The third bearing point 19 acts as a pivot axis for the tilt levers 13 and 14, so that they can execute a rocking motion when the stroke of the piezoelectric actuator 2 acts on the tilt levers 13 and 14. A bearing plate 15, which is disposed fixedly in the housing 20 of the valve, acts as a counterpart bearing for the tilt levers 13 and 14. The boosting ratio A:B of the tilt levers 13 and 14 is determined by the spacings of the bearing points 17, 18 and 19 in the longitudinal direction of the tilt levers (see FIG. 1).

As also shown in FIG. 1, the valve element 6 closes a valve seat 7, as a result of which a communication with a control chamber 9 can be closed and opened. A control piston 10 is disposed in the control chamber 9 and controls an actuation of an injector (not shown). Via a line 11, the control chamber 9 communicates with the high-pressure region of the injection system.

The function of the valve for controlling fluids of the first exemplary embodiment is as follows:

A longitudinal stroke in the direction of the arrow C of the piezoelectric actuator 2 is transmitted to the kidney-shaped tilt levers 13 and 14 via the platelike actuating element 16 and via the bearing points 18. As a consequence of the stroke, the two tilt levers 13 and 14 each rotate about the pivot shafts in the bearing points 19 between the tilt levers 13 and 14 and the bearing plate 15, so that the end of the tilt levers in contact with the bearing points 17 by way of the intermediate member 5 is moved upward, that is, in the direction of the piezoelectric actuator 2. As a result, the bridgelike intermediate member 5 is likewise moved upward, counter to the spring force of the restoring spring 4. Since the intermediate member 5 and the piston 8 which holds the valve element 6 are solidly connected to one another, the valve element 6 can be lifted from the valve seat 7 because of this motion, as a result of the high pressure in the control chamber 9. This causes a pressure drop in the control chamber 9, since the fluid can flow out via a throttle 12 and the open valve seat 7. As a result, the control piston 10 moves upward, and a fuel injection at an injector ensues.

When the piezoelectric actuator 2 is deactivated, it moves into its outset position again and back, so that by the spring force of the restoring spring 4 via the bridgelike intermediate member 5, the tilt levers 13, 14 and the valve element 6 are returned to their outset positions. As a result of that, the valve element 6 closes the valve seat 7 again, so that a pressure can build up in the control chamber 9, by which pressure the control piston 10 is moved downward, so that the injector closes again.

Because of the embodiment of the mechanical booster for the stroke of the piezoelectric actuator with kidney-shaped tilt levers 13, 14, a very rigid stroke boost can be effected, as compared with the prior art. As a result, the injection times for the injector can be adhered to with high precision. Moreover, the mechanical booster 3 requires only little space, and so a compact valve for controlling fluids can be furnished. This has advantages both in terms of installation in tight engine compartments and in terms of reducing weight, because there is only a small number of individual parts, and these individual parts are small in size.

It is also advantageous that by a simple change in the length ratios A:B of the tilt levers 13 and 14, the boosting ratio can be varied in a simple way. That is, a standardized valve for controlling fluids can be furnished in which for various boosting ratios, only suitably embodied kidney-shaped tilt levers with different boosting ratios need to be kept on hand for various engine manufacturers. This has pronounced cost advantages in production.

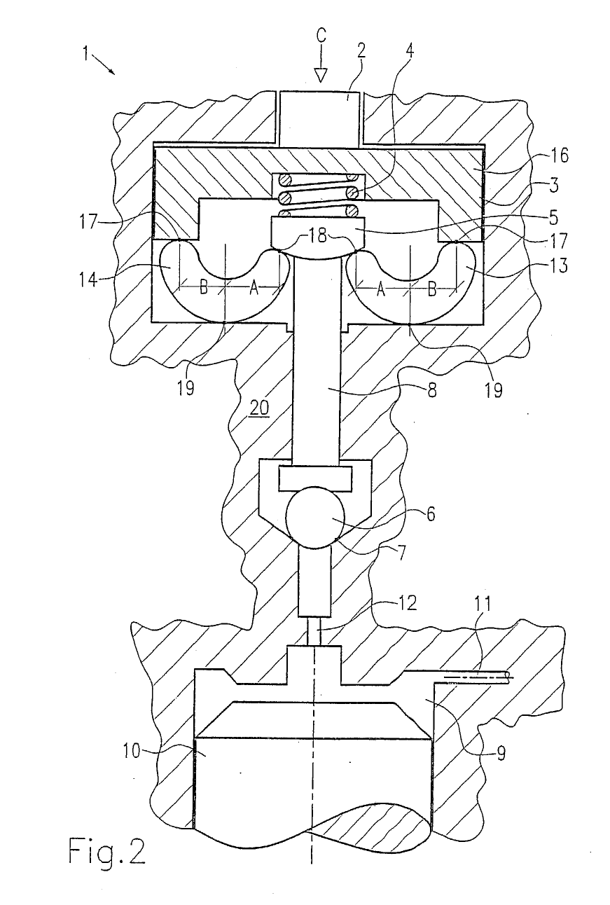

In FIG. 2, a second exemplary embodiment of a control valve for an injector for injecting fuel is shown. Parts that are the same or functionally the same are identified by the same reference numerals as in the first exemplary embodiment. Since the second exemplary embodiment is essentially equivalent to the first exemplary embodiment, only the differences will be explained in detail below.

In a distinction from the first exemplary embodiment, in the second exemplary embodiment the piezoelectric actuator 2 is in direct contact with a bridgelike actuating element 16. The actuating element 16, in its peripheral regions, has bearing points 17 by way of which the actuating element is in contact with the two tilt levers 13 and 14. Similarly to the first exemplary embodiment, the two tilt levers 13 and 14 are supported on the housing 20 of the valve 1 at bearing points 19. The two tilt levers 13 and 14 are in turn in contact at bearing points 18 with a platelike intermediate member 5, which in turn is solidly connected to a piston 8. As in the first exemplary embodiment, the piston 8 is again in contact with a valve member 6, which closes a valve seat 7. A restoring spring 4 is disposed between the bridgelike actuating element 16 and the platelike intermediate member 5.

The function of the valve in the second exemplary embodiment is as follows: When a stroke of the piezoelectric actuator 2 in the direction of the arrow C is effected, this stroke is transmitted to the actuating element 16, moving it downward, that is, in the direction of the valve element 6. As a result, the two kidney-shaped tilt levers 13 and 14 are pivoted about their pivot axes 19, so that the ends of the tilt levers 13 and 14 that are in contact with the intermediate member 5 are moved upward. Because of this, and because of the motion of the actuating element 16, the restoring spring 4 is compressed. Also via the intermediate member 5, the piston 8 and thus the valve element 6 are moved upward, so that the valve element 6 lifts from the valve seat 7. As a result, fluid can flow out of the control chamber 9 via the throttle 12 through the valve seat 7, and as a result the control piston 10, which is in contact with an injector (not shown), is moved upward. The result is an injection into a combustion chamber.

After the deactivation of the piezoelectric actuator 2, the actuating element 16 moves back into its outset position, as a result of which the tilt levers 13 and 14 are also moved into their outset positions. This is effected because of the spring force of the restoring spring 4, which expands into its outset position again. As a result, the valve element 6 is pressed against the valve seat 7 again, so that the valve seat 7 is closed. As a result of that, a pressure can build up in the control chamber 9 again, so that the control piston 10 is moved downward and the fuel injection is terminated.

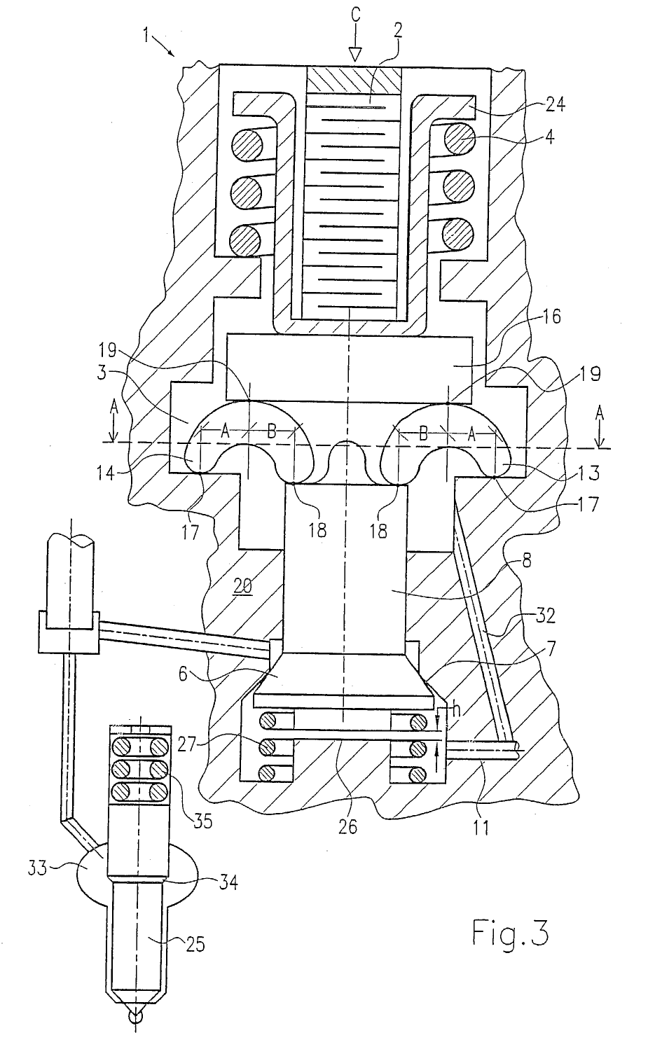

In FIGS. 3-5, a control valve 1 of the third exemplary embodiment of the present invention is shown. Identical or functionally identical parts are identified by the same reference numerals as in the exemplary embodiments described above. Since the third exemplary embodiment is essentially equivalent to the exemplary embodiments described above, only the distinctions will be explained in detail below.

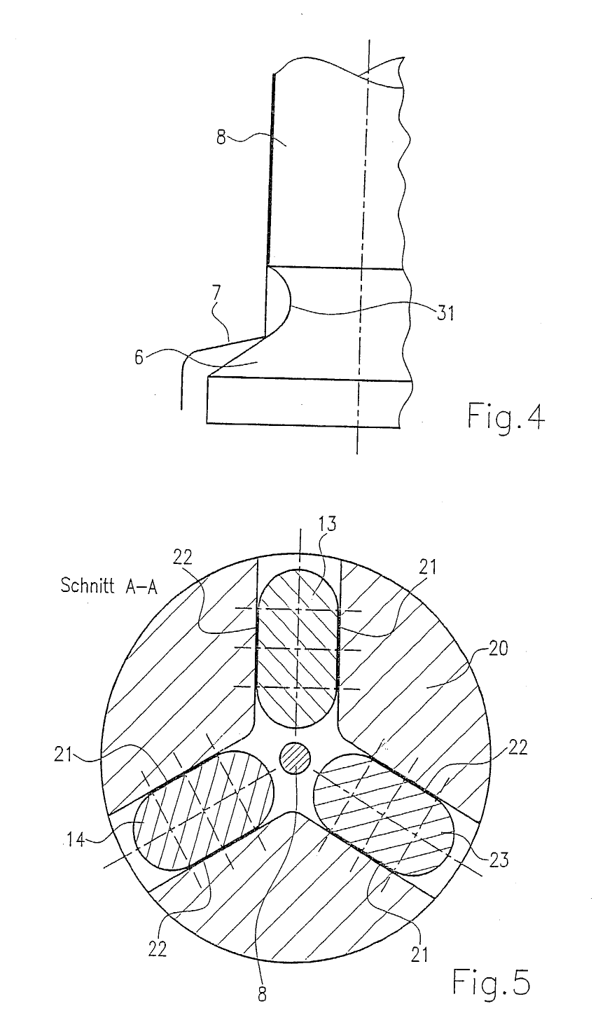

In this exemplary embodiment, the mechanical booster 3 comprises three tilt levers 13, 14 and 23 (see FIG. 5). The tilt levers are spaced apart from one another by 120° each. A platelike actuating element 16 is also provided, which is in contact with a piezoelectric actuator 2 via a top-hat-shaped valve element 24. A restoring spring 4, which is braced against a shoulder in the housing 20, is disposed on the rim of the top-hat-shaped valve element 24.

As shown in FIG. 3, the tilt levers 13, 14 and 23 are in direct contact with a piston 8 via bearing points 18. On the piston 8, a valve element 6 is provided which is embodied integrally with the piston 8. As the detail in FIG. 4 shows, the piston 8 is embodied such that its guide diameter is equivalent to a seat diameter of the valve element 6. To that end, an annular-groovelike recess 31 is embodied between the piston 8 and the valve element 6. The space in which the mechanical booster 3 is disposed communicates via a line 32 with the supply line 11 for supplying fuel.

As also shown in FIG. 3, a stroke stop 26 for limiting a stroke height h of the piston 8 is embodied on the end of the piston 8 opposite the mechanical booster 3. A second restoring spring 27 is also disposed on this same end of the piston 8, and the stroke stop 26 also serves as a spring seat for the spring 27.

The function of the valve 1 in the third exemplary embodiment is as follows: A stroke of the piezoelectric actuator 2 in the direction of the arrow C is transmitted via the valve element 24 to the platelike actuating element 16. As a result, also via the valve element 24, the restoring spring 4 is compressed. Via the actuating element 16, the stroke is transmitted to the kidney-shaped tilt levers 13 and 14 via the bearing points 19. As a result, the tilt levers each pivot about pivot axes through the bearing points 17, so that the piston 8, which is in contact with the tilt levers via the bearing points 18, is moved downward. As a result, the valve element 6 formed integrally on the piston 8 lifts away from the valve seat 7. The fuel supply line 11 thus communicates via further lines with a control chamber 33 of the injector 25. As a result, the pressure in a control chamber 33 increases, causing the injector 25 to move upward via a riblike protrusion 34, counter to the spring force of a restoring spring 35, and a fuel injection into a combustion chamber can ensue.

The injection of fuel is continued until such time as the piezoelectric actuator 2 is deactivated and the mechanical booster and the valve element 6 are moved back into their outset positions again via the respective restoring springs 4 and 27. As a result, the valve element 6 at the valve seat 7 closes. The injector 25 is thus also returned to its outset position via the restoring spring 35 and thus closes the injection opening.

As shown in FIG. 5, in the valve 1 of the third exemplary embodiment, the three kidney-shaped tilt levers 13, 14 and 23 are guided laterally at regions 21 and 22 which are formed in the housing 20 of the valve 1. By means of these guides 21 and 22, a tilt lever system of particularly high rigidity is furnished. Since the space in which the mechanical booster 3 is disposed is supplied with fuel, an adequate lubrication also exists between the tilt levers 13, 14 and 23 and the respective guides 21 and 22. This assures reliable actuation of the piston 8 and of the valve element 6.

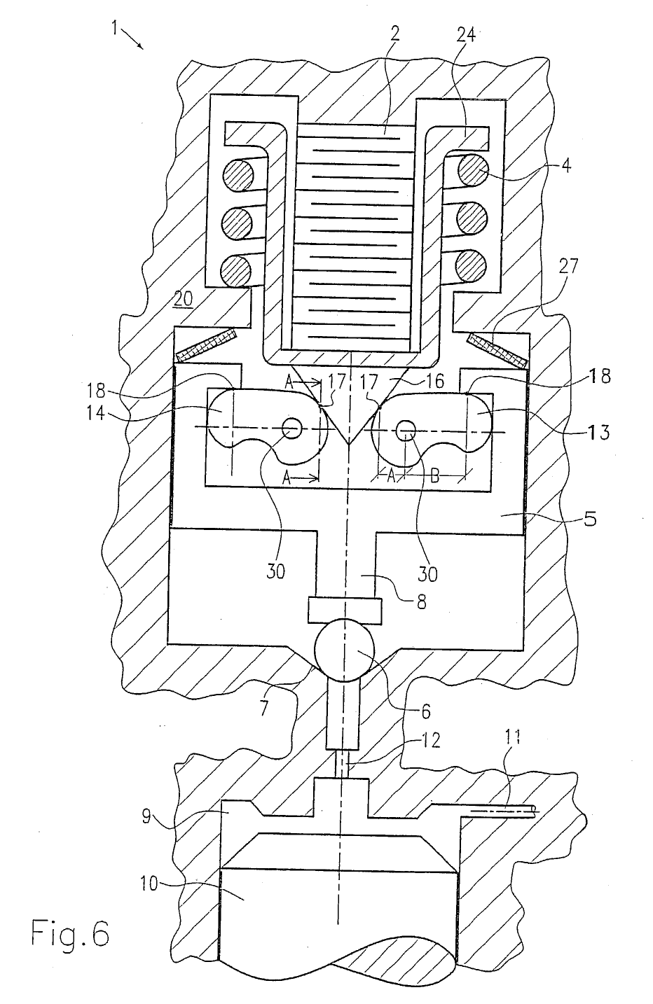

In FIGS. 6, 7a-7c, 8a and 8b, a fourth exemplary embodiment of a control valve for an injector for injecting fuel is shown. Identical or functionally identical parts are identified by the same reference numerals as in the first exemplary embodiment. Since the fourth exemplary embodiment is essentially equivalent to the third exemplary embodiment, only distinctions will be described in detail below.

As shown in FIG. 6, in contrast to the third exemplary embodiment, in the fourth exemplary embodiment an actuating element 16 is provided which has a tapering region, which is in contact with the tilt levers 13 and 14. Thus a reciprocating motion of the piezoelectric actuator 2 is transmitted to the tilt levers 13 and 14 via the tapering actuating element 16. Also, in contrast to the exemplary embodiments described above, the tilt levers are axially supported in the transverse direction (perpendicularly to their length). To that end, a shaft 30 is provided, which is guided through a through opening formed in each of the tilt levers 13 and 14. This is shown on a larger scale in FIG. 8b. The shaft 30 is in turn supported in the housing 20 of the valve.

Thus in contrast to the above-described exemplary embodiment, the pivot axis of the tilt levers 13 and 14 is not located in a bearing region but rather in the region of the pivot axis D-D formed by the shaft 30. Thus the tilt levers 13 and 14 each have only two bearing points 17 and 18. At their bearing points 18, the two tilt levers 13 and 14 are each in contact with a bridgelike intermediate member 5, which is formed integrally with a piston 8 that restrains a valve element 6. Also, besides the restoring spring 24 on the top-hat-shaped valve element 24, a second restoring spring 27, embodied as a plate spring, is provided, which is braced both on the intermediate member 5 and on the housing 20.

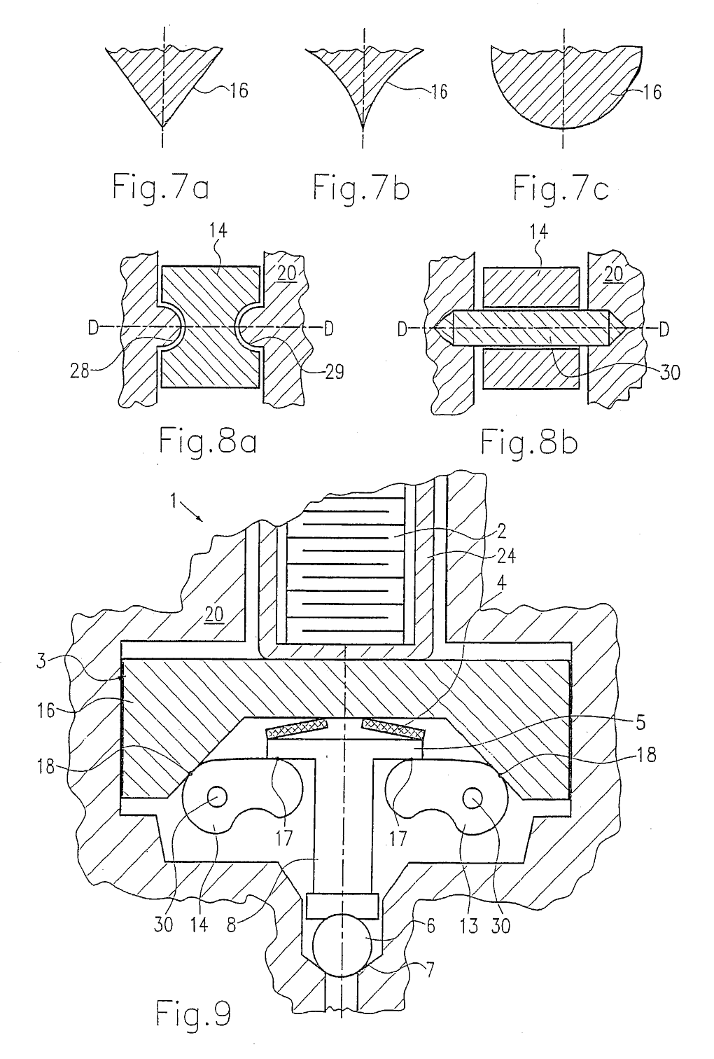

In FIGS. 7a, 7b and 7c, various possible embodiments of the tapering actuating element 16 are shown. In FIG. 7a, the actuating element 16 is embodied conically, making the actuating element 16 especially easy to produce. In FIG. 7b, the actuating element 16 narrows in section parabolically, which makes it possible to actuate the tilt levers in a region located relatively far outward. In particular, this means that a high lever ratio can be attained. FIG. 7c shows an actuating element 16 which is embodied hemispherically.

In FIG. 8a, an alternative support of the tilt levers in the fourth exemplary embodiment is shown. As shown in FIG. 8a, luglike protrusions 28 and 29 are formed in the housing 20, which engage complementary recesses in the tilt levers 13 and 14. As a result, the tilt levers can rotate about the axis D-D formed by the protrusions 28 and 29. The protrusions 28 and 29 are preferably embodied hemispherically, thus assuring easy pivotability of the tilt levers.

The function of the valve 1 in the fourth exemplary embodiment will now be described below. When the piezoelectric actuator 2 is activated, the piezoelectric actuator 4 lengthens in the direction of the valve element 6. This stroke of the piezoelectric actuator 2 is transmitted via the valve element 24 to the tapering actuating element 16. In the process, the restoring spring 4 is compressed. Via the two bearing points 17, the motion of the actuating element 16 is transmitted to the two kidney-shaped tilt levers 13 and 14. Since the two tilt levers 13 and 14 are each solidly supported on the housing 20 via the shaft 30, they rotate about the shaft 30, thus moving the bridgelike intermediate member 5 upward counter to the spring force of the plate spring 27. As a result, the valve element 6 is lifted from the valve seat 7, and thus fluid can flow out from the control chamber 9 via the throttle 12 through the valve seat 7. As a result, in a known manner, the control piston 10 is moved upward, and an injection of fuel ensues.

When the piezoelectric actuator 2 is deactivated, both the valve element 6 and the component parts of the mechanical booster 3 are returned to their outset positions via the restoring spring 4 and the plate spring 27. As shown in FIG. 6, the lever ratio A:B in the fourth exemplary embodiment is determined by the spacings between the bearing points 7 and the pivot shaft 30 and the spacings between the bearing points 18 and the pivot shaft 30 and again amounts to A:B.

In FIG. 9, a fifth exemplary embodiment of a control valve 1 for an injector is shown. Identical or functionally identical parts are identified by the same reference numerals as in the exemplary embodiments described above. Since the fifth exemplary embodiment is essentially equivalent to the fourth exemplary embodiment, only the distinctions will be described in detail below.

In a distinction from the fourth exemplary embodiment, in the fifth exemplary embodiment a stroke of the piezoelectric actuator 2 is transmitted to a bridgelike actuating element 16 via the top-hat-shaped valve element 24. This stroke is then transmitted via the bearing points 18 and 17 of the tilt levers 13 and 14 to a platelike intermediate member 5, which is in contact with a valve element 6 via piston 8. Similarly to the second exemplary embodiment, a restoring spring 4 is disposed between the actuating element 16 and the intermediate member 5.

As in the fourth exemplary embodiment, the tilt levers 13 and 14 are again supported on shafts 30, so that they each have only two bearing points 17 and 18 in the mechanical booster 3. Otherwise, the fifth exemplary embodiment is equivalent to the fourth exemplary embodiment, and so it need not be described further here.

According to the invention, by the use of kidney-shaped tilt levers in a mechanical booster, a stroke of an actuator can accordingly be transmitted, with high system rigidity being assured. The actuator can be embodied as a piezoelectric actuator or as a magnetically driven actuator. The high rigidity in transmitting the actuator stroke makes a very precise valve control possible. Moreover, the valve with the booster of the invention requires only little installation space and has only a low weight.

Thus according to the invention a valve for controlling fluids is furnished which has an actuator 2 and a mechanical booster 3 for boosting a stroke of the actuator 2. A restoring spring 4 and a valve element 6 are also provided. The booster 3 is embodied as a kidney-shaped tilt lever (13, 14, 23), which has point-type bearing points.

The above description of the exemplary embodiments of the present invention is intended solely for illustrative purposes and not for limiting the invention. Within the scope of the invention, various changes and modifications may be made without departing from the scope of the invention or its equivalents.

1. A valve for controlling fluids, having an actuator (2), a mechanical booster (3) for boosting a stroke of the actuator (2), a restoring spring (4, 27), and a valve element (6), characterized in that the booster is embodied as a kidney-shaped tilt lever (13, 14, 23), which has point-type bearing points (17, 18, 19).

2. The valve for controlling fluids of claim 1, characterized in that the booster embodied as a kidney-shaped tilt lever (13, 14, 23) is positionally fixed in a transverse axis (D-D).

3. The valve for controlling fluids of claim 2, characterized in that the positional fixation is furnished by means of a shaft (30) guided by the tilt lever (13, 14, 23), or by means of two lateral guide elements (28, 29).

4. The valve for controlling fluids of one of claims 1-3, characterized in that the tilt lever (13, 14, 23) has precisely three point-type bearing points (17, 18, 19).

5. The valve for controlling fluids of one of claims 1-4, characterized in that the actuator (2) is in contact with an actuating element (16), which actuates the tilt lever (13, 14, 23).

6. The valve for controlling fluids of claim 5, characterized in that the actuating element (16) is embodied as a bridge or plate or has a tapering tip.

7. The valve for controlling fluids of one of claims 1-6, characterized in that the mechanical booster (3) has many tilt levers (13, 14, 23).

8. The valve for controlling fluids of one of claims 1-7, characterized in that the mechanical booster (3) is constructed symmetrically.

9. The valve for controlling fluids of one of claims 1-8, characterized in that a valve element (6) of the valve is embodied integrally on the actuating piston (8), and a diameter of a valve seat (7) is equivalent to a diameter of the actuating piston (8).

10. The use of a valve for controlling fluids of one of claims 1-9 in an injection device for a common rail system.
